(19) United States
(12) Patent Application Publication
(10) Pub. No.: US 2008/0295173 A1
(43) Pub. Date: Nov. 27, 2008

(54) PATTERN-BASED NETWORK DEFENSE MECHANISM

(76) Inventor: Tsvetomir Iliev Tsvetanov, Sofia (BG)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/838,812

(22) Filed: Aug. 14, 2007

Related U.S. Application Data
(60) Provisional application No. 60/939,295, filed on May 21, 2007.

(51) Int. Cl. G06F 11/30; G06F 11/34; G06F 15/16

(52) U.S. Cl. 726/23; 726/22; 726/25

(57) ABSTRACT

Method, system and machine accessible medium for pattern based network defense. The traffic flow in a network is tracked independently form the payload data in the flow. The traffic flow pattern is compared with a set of predefined malicious traffic patterns descriptions. An event is triggered responsive to a match between a subset of the traffic patterns and the predefined malicious traffic descriptions.

### BACKGROUND

1. Field of Invention

The field of invention relates generally to the software arts, and, more specifically, to network security.

2. Background

Network security addresses the protection of stored data, network communications, and network services from internal or external threats such as unauthorized access or inefficient performance. There are different approaches to secure a network: user authentication, firewalls, intrusion prevention and detection, traffic encryption, etc. Each approach provides protection against particular types of threats and often they are used in combination. However, none, nor any combination of them, is sufficient to guarantee absolute protection. Network security is about reducing the risk to an acceptable level.

One of the most effective network protection technologies is the intrusion detection systems (IDS). The basic approach of IDS is to monitor the content of network traffic to detect malicious activities such as denial of services (DoS) attacks, port scans, application cracking, unauthorized logins, etc. The access to the network traffic for monitoring is provided through a host computer or a network communication device such as a router or a switch. The IDS detects malicious traffic by reading all exchanged data packets carried by the network and trying to find suspicious content. For example, a large number of TCP connection requests to a very large number of different ports might be an indication for a port scan.

The implementation and the support of IDS require strong administrator skills to identify and setup proper definitions for different malicious types of traffic content. Current IDS solutions provide rule-based detection mechanism where, with the help of meta-programming languages, network administrators may input known malicious traffic characteristics and a variety of other rules to identify malicious activities in a network. The detection mechanism uses these characteristics and rules to map against the traffic and, in case at least one packet matches, to take predefined operations: for example, a log action.

In most cases, IDS solutions analyze the whole Open System Interconnection (OSI) stack from data link to application layer (as defined by the OSI seven layer communication model, set by the International organization of standardization (ISO)). The implementation and maintenance of such a comprehensive solution is usually very expensive and strongly dependant on staff training, skills and experience.

### SUMMARY

A method, system and machine accessible medium for pattern based network defense are described. The traffic flow in a network is tracked independently form the payload data in the flow. The traffic flow pattern is compared with a set of predefined malicious traffic flow patterns and an event is triggered responsive to a match between a subset of the traffic flow patterns and the predefined flow patterns.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a flow pattern based defense mechanism according to one embodiment of the invention.

FIG. 2 is a block diagram of a software system, providing functionality for matching the tracked traffic patterns against the set of predefined patterns according to one embodiment of the invention.

FIG. 3 is a flowchart of uploading predefined malicious traffic patterns and matching with the tracked traffic patterns according to one embodiment of the invention.

FIG. 4 illustrates examples of malicious network traffic definitions.

### DETAILED DESCRIPTION

Embodiments of a method, system and machine accessible medium for pattern based network defense are described herein.

Embodiments of the invention compare network traffic flow pattern with a number of predefined malicious traffic flow patterns. There are various instruments for capturing network traffic flow. Generally the vendors of network management software collect this data in specific databases for further administration. The invention in its different embodiments could use for its purposes network traffic flow data collected in different aggregations and formats by various vendor specific instruments. In one embodiment of the invention, the network traffic flow is captured using Cisco NetFlow, which is a log export technology, integrated in devices manufactured by Cisco Systems Inc. of San Jose Calif. Other embodiments may use other network traffic flow capturing technology or tools.

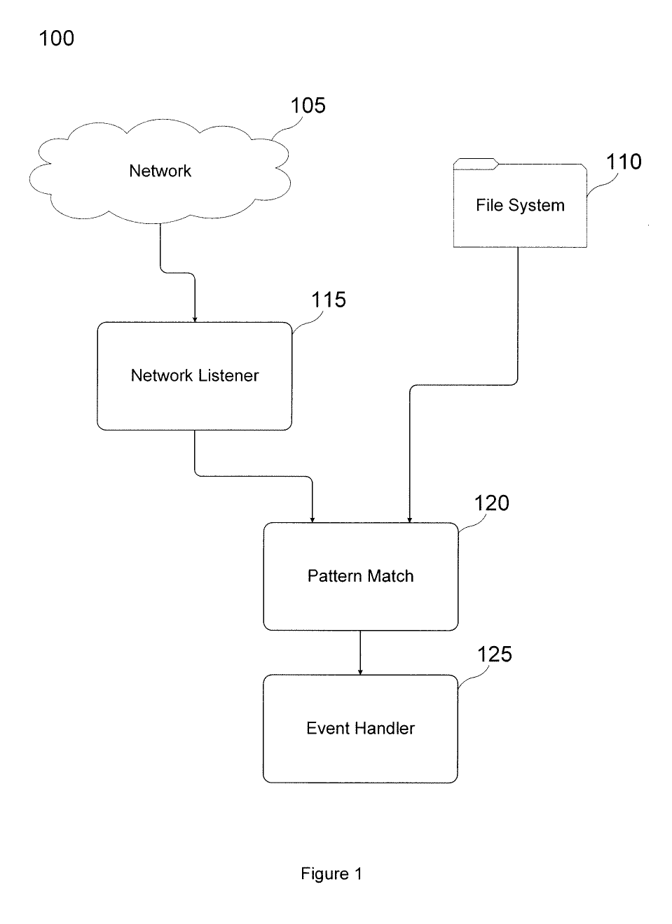

FIG. 1 is a block diagram of a flow pattern based defense mechanism according to one embodiment of the invention. The network listener 115 receives the network traffic captured in the network 105. From the network listener 115, the network traffic information is transferred to the pattern match 120 where it is compared with the predefined malicious traffic patterns. In one embodiment of the invention, only the network traffic passing through a plurality of communication devices in the network 105 is captured and sent to the network listener 115. Communication devices for the purposes of this specification include, for example, network routers, network switches and network hubs.

In one embodiment of the invention, the malicious traffic patterns are described in text format using a definition language with simple semantic. In another embodiment of the invention, the malicious traffic patterns could be described using standardized languages such as extensible markup language (XML). A pattern description is a set of statements describing characteristics of traffic flow. Certain patterns are commonly exhibited by malicious traffic. As used herein, “malicious traffic descriptions” are descriptions of traffic flow patterns likely to be associated with or exhibited by malicious traffic. In one embodiment, a plurality of malicious traffic pattern descriptions, previously stored in a number of flat files in file system 110, are read by pattern match 120 and are mapped against the captured network traffic flow. In one embodiment of the invention, pattern match 120 also provides a user interface with entry fields for direct input of malicious traffic descriptions.

Pattern match 120 has simultaneous access to the network flow and to the malicious traffic descriptions stored in the file system or input through a computer interface. In accordance with a set of matching rules, pattern match 120 runs a checking process that maps the current network traffic flow against the malicious traffic descriptions. If the process, run by pattern match 120 in accordance with the matching rules, recognizes malicious traffic, it triggers an assigned action to be performed. This action is handled by event handler 125 and could include: exporting information about the detected malicious traffic, logging data related to the malicious traffic, sending notification to an administrator of an attacked network node, blocking traffic from a host who generates the detected malicious traffic, closing an attacked port, or additional traffic analysis, or a combination of the foregoing.

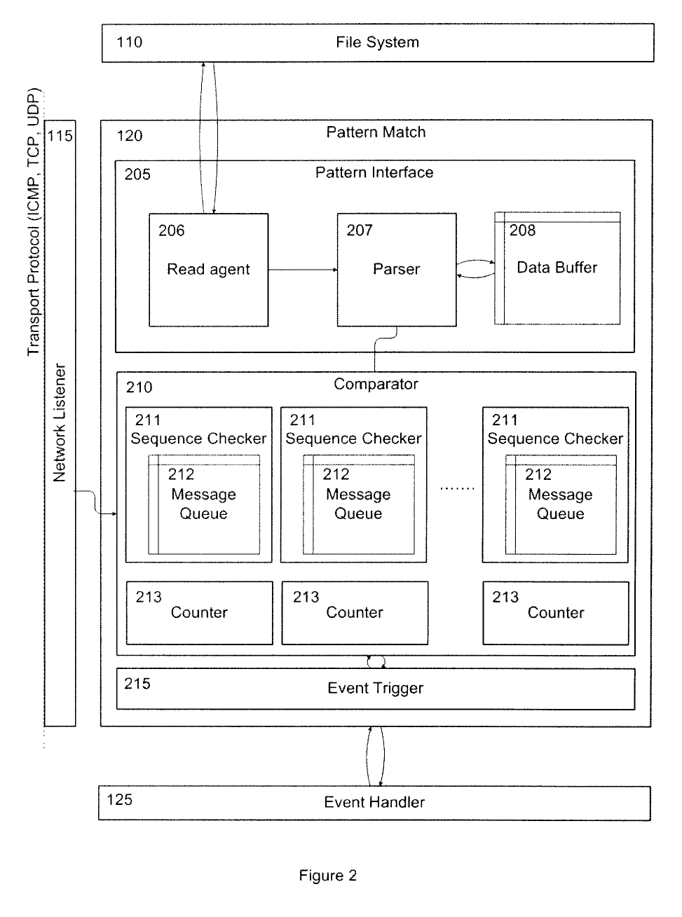

FIG. 2 is a block diagram of a software system providing functionality for matching the tracked traffic patterns against the set of predefined patterns according to one embodiment of the invention. The main modules of pattern match 120 include pattern interface 205, comparator 210, and event trigger 215. Each module provides specific functionality required in the checking process. Comparator 210 maps the current network traffic flow data against each of the malicious traffic descriptions. The traffic flow data is available directly through network listener 115, and pattern interface module 205 delivers the malicious traffic descriptions. If the traffic flow matches a predefined malicious traffic description, event trigger 215 triggers a task to be managed by event handler 125.

Pattern interface 205 includes three separate sub-modules: read agent 206, parser 207, and data buffer 208. Read agent 206 is responsible for accessing the files containing malicious traffic descriptions and sending the descriptions to parser 207. In one embodiment of the invention, read agent 206 receives and transfers malicious traffic descriptions directly input into user interface entry fields. In another embodiment, read agent 206 accesses malicious traffic descriptions from a storage device such as the file system. In such an embodiment, a storage agent must first store the user input description in, for example, the file system. After the description is stored, read agent 206 may access and send the description to parser 207.

Parser 207 parses the malicious traffic definitions to validate them. In various embodiments, parsing may include, for example, performing syntax and semantic analyses on the malicious traffic definitions. If found valid, the definitions are stored by parser 207 in data buffer 208. In one embodiment of the invention, data buffer 208 acts as a memory cache in which data is dynamically stored and ordered for mapping against the current traffic flow patterns. After the definitions are stored, they are active (i.e. they are available for mapping). Parser 207 extracts the data from data buffer 208 and delivers it to comparator 205 responsive to the checking process requests.

The collected traffic data is mapped against or compared with the stored malicious traffic descriptions by comparator 210 module. Comparator 210 verifies whether the traffic exhibits the same characteristics as described in the malicious traffic definitions. In mapping the traffic flow against the malicious traffic descriptions, the comparator uses additional handling sub-modules, sequence checker 211 and counter 213. Sequence checker 211 is instantiated when a malicious traffic description includes the characteristics of address or port sequencing threats (e.g., a series of requests from a host with incremental changes in target address or port number, or both). Sequence checker 211 caches the network traffic data flow in a specific format and order for a predefined period of time. The data is cached in message queue 212 and is queried by sequence checker 211 to detect an address or port based sequencing threat. In one embodiment of the invention, separate sequence checker 211 is instantiated for each malicious traffic description having the characteristics of address or port based sequencing threats.

Counter 213 is instantiated when a malicious traffic description includes a characteristic frequency threat (e.g., an abnormally high number of requests directed to particular host address or port). When Comparator 210 detects a traffic-to-pattern match, it calls counter 213 to iterate the matches. Counter 213 calculates the matches per second (mps) and returns true if the mps value is greater than the predefined value in the malicious pattern description. In one embodiment of the invention, counter 213 stores a pointer to the malicious pattern description, startup time values, and matches. Separate counter 213 may be instantiated for each malicious traffic description having the characteristics of frequency threats. Counter 213 may also be enhanced to store a predefined number of matches for further analysis instead of issuing directly an entry match.

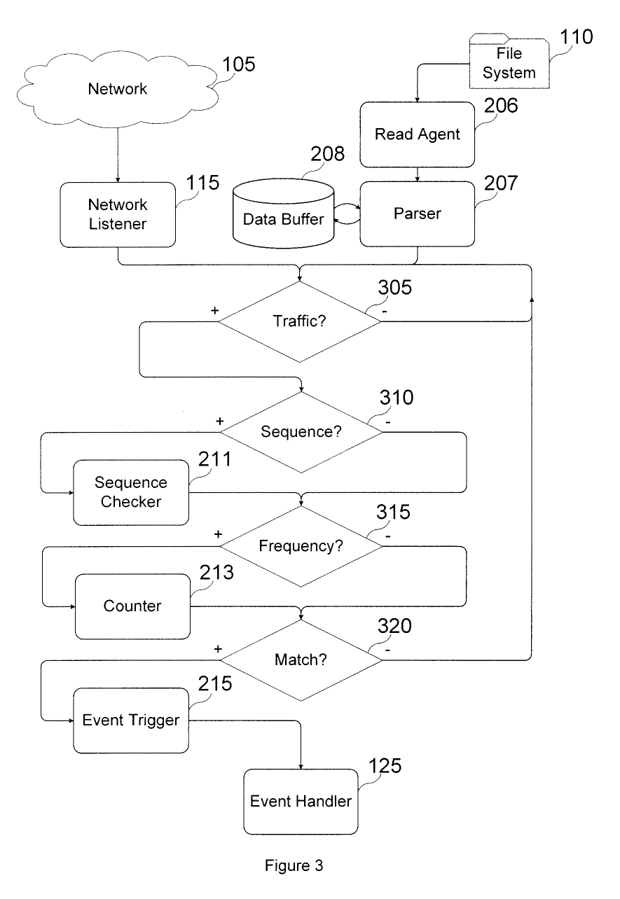

FIG. 3 is a flowchart of a method for uploading predefined malicious traffic patterns and matching with the tracked traffic flow patterns according to one embodiment of the invention. The check method is performed by the checking process, referred bellow in this document also as matching or mapping process. The malicious traffic descriptions of a plurality of predefined patterns are stored in file system 110. With the initial start of the checking process, read agent 206 accesses the files and provides the file contents to parser 207 for validation. The valid descriptions are then stored in data buffer 208 for dynamic access during the checking process.

After the initialization and description validation, network traffic is monitored for tracked network traffic data to be mapped against the malicious traffic descriptions. Network listener 115 provides access to the captured traffic flow when there is traffic flow in the network. At block 305, the availability of tracked traffic to be examined is verified. In one embodiment of the invention, only Network Layer traffic and Transport Layer traffic are examined (layer 3 and layer 4 respectively according to OSI computer communication model).

At block 310, a determination is made if definitions for sequence threats exist among the malicious traffic patterns descriptions. If sequence threat definitions exist, a corresponding number of sequence checker sub-modules 211 are instantiated. At block 315 is checked if frequency threat definitions exist among the malicious traffic patterns descriptions. If frequency threat definitions exist, a corresponding number of counter sub-modules 213 are instantiated.

At block 320, the tracked traffic flows are mapped against the malicious traffic descriptions. The predefined pattern description language identifies how to process the received network traffic flow data. If the behavior of the traffic flow corresponds to one or more of the predefined patterns, an event is triggered at the event trigger 215 and the event handler 125 associates and manages the corresponding action of the event triggered.

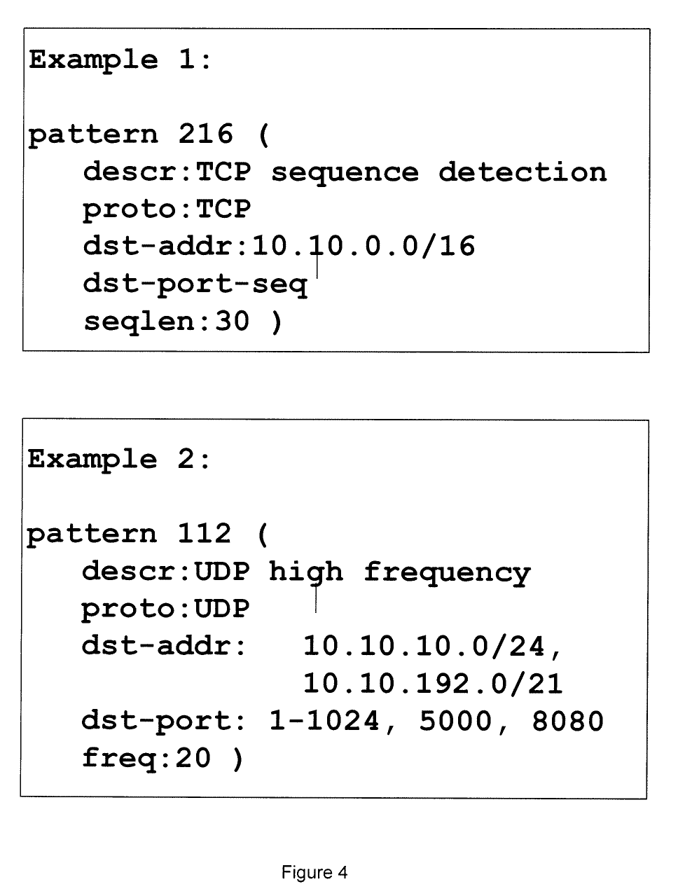

FIG. 4 illustrates examples of malicious network traffic definitions. In the first example, the matching process examines tracked Transmission Control Protocol (TCP) traffic, according to the OSI model. The network flow is checked for a sequence threat in the form of destination port scanning for particular segment of the network with addresses between 10.10.0.0 and 10.10.255.255. The traffic matches the pattern and consequently a matching event is fired if the process finds thirty sequential ports in the requests targeting hosts in this network segment.

The second example presents malicious pattern definition to be mapped against User Datagram Protocol (UDP) traffic, according to the OSI model. The pattern from the example instructs the matching process to search for high frequency—more than 20 per second—requests to hosts in two network segments, the first with addresses between 10.10.10.0 and 10.10.10.255, and the second with addresses between 10.10.192.0 and 10.10.199.255. A set of destination ports for the requests to be counted is also defined—“1-1024, 5000, 8080”. A match event is triggered by the process if it counts more than 20 requests per second to a host and port from the defined intervals.

An advantageous embodiment of the invention allows the checking process to manage a graphic user interface. One of the possible functions of the graphic user interface is to permit entry of malicious traffic descriptions at run time. The patterns could be entered from a file by browsing the file system through this interface, or could be directly entered in onscreen editable fields. If a malicious traffic description is entered at runtime, the Pattern Interface is reinitialized and the changed set of predefined malicious traffic descriptions are mapped with the tracked traffic.

Among the possible embodiments of the described inventions is a software application system, a software API, a pluggable module to IDS, Firewalls and other network security management systems to identify the excessive IP traffic with specific characteristics.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Reference throughout this specification to “one embodiment” or “an embodiment” means that a particular feature, structure or characteristic described in connection with the embodiment is included in at least embodiment of the invention. Thus, the appearance of the phrases “in one embodiment” or “in an embodiment” in various places throughout this specification are not necessarily all referring to the same embodiment. Furthermore, the particular features, structures or characteristics may be combined in any suitable manner in one or more embodiments.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
tracking traffic flow patterns in a network independent from any payload data in the flow;
comparing the traffic flow patterns with a set of predefined patterns; and
triggering an event responsive to a match between a subset of the traffic flow patterns and the predefined patterns.

2. The method of claim 1, wherein tracking traffic flow patterns further comprises:
receiving data in a predefined format via a plurality of networked communication devices, the predefined format containing information about traffic flow.

3. The method of claim 1 further comprising:
tracking Network layer (Layer 3) and Transport layer (Layer 4) traffic in an Open System Interconnection (OSI) computer communication model.

4. The method of claim 1, wherein comparing the traffic comprises:
uploading a plurality of malicious network traffic pattern definitions;
accessing the tracked traffic flow; and
scanning the tracked traffic for subsets which match the malicious traffic patterns.

5. The method of claim 4, wherein scanning the tracked traffic comprises:
searching for an incremental call sequence; and
counting a number of occurrences of a particular pattern in the tracked traffic responsive to finding the call sequence.

6. The method of claim 5 wherein the incremental call sequence is one of an incremental host address call sequence or an incremental port number call sequence.

7. The method of claim 4, wherein uploading a plurality of malicious network traffic patterns comprises:
reading a plurality of malicious traffic pattern descriptions from one of a file or a user interface entry;
validating the syntax and semantics of the malicious traffic pattern descriptions; and
activating the malicious traffic pattern descriptions.

8. The method of claim 1, wherein triggering an event comprises:
triggering an event for automatic reaction against a detected network threat, the event comprising at least one of exporting information about detected malicious traffic, logging data related to the malicious traffic, sending notification to an administrator of an attacked node, blocking traffic from a host who generates the detected malicious traffic, closing an attacked port, additional algorithmic analyses.

9. A system comprising:
an element to capture information about traffic flow;
a data holder to retain traffic flow patterns independently from any payload data in the flow;
an interface to receive malicious traffic patterns definitions;
a comparator to compare the tracked traffic flow patterns with a set of the predefined patterns; and
an interface to trigger an event in response to a match between a subset of the traffic flow patterns and the predefined patterns.

10. The system of claim 9, wherein a data holder comprises:
a data structure to receive and persist data in a predefined format about data flow from a plurality of networked communication devices.

11. The system of claim 10, wherein the data structure receives and persist Network layer (Layer 3) and Transport layer (Layer 4).

12. The system of claim 9, wherein the interface to receive malicious traffic patterns definitions further comprises:
an agent to read a plurality of malicious traffic patterns descriptions from one of a file and a user interface entry;
a parser to validate a syntax and semantics of the malicious traffic patterns descriptions; and
a data buffer to persists the patterns.

13. The system of claim 9 wherein the comparator further comprises:
a sequence checker to identify incremental call sequence; and
a counter to count the occurrences of a particular pattern in the tracked traffic flow.

14. The system of claim 13 wherein the incremental call sequence is one of an incremental host address call sequence or an incremental port number call sequence.

15. The system of claim 9, wherein the interface to trigger an event comprises:
an interface to trigger an event to automatically react to a detected network threat, the event comprising at least one of exporting information about detected malicious traffic, logging data related to the malicious traffic, sending notification to an administrator of an attacked node, blocking traffic from a host who generates the detected malicious traffic, closing an attacked port, or additional algorithmic analyses.

16. A machine accessible medium that provides instructions that, if executed by a machine, will cause the machine to execute operations comprising:
tracking traffic flow patterns in a network independently from any payload data in the flow;
comparing the traffic flow patterns with a set of predefined patterns; and
triggering an event responsive to a match between a subset of the traffic flow patterns and the predefined patterns.

17. The machine accessible medium of claim 16, wherein tracking traffic flow patterns further comprises:
receiving data in a predefined format about data flow through a plurality of networked communication devices.

18. The machine accessible medium of claim 16, further providing instructions that, if executed by the machine, will cause the machine to perform further operations, comprising:
tracking Network layer (Layer 3) and Transport layer (Layer 4) traffic in an Open System Interconnection (OSI) computer communication model.

19. The machine accessible medium of claim 16, wherein comparing the traffic comprises:
uploading a plurality of malicious network traffic pattern definitions;
accessing the tracked traffic flow; and
scanning the tracked traffic for subsets which match the malicious traffic patterns.

20. The machine accessible medium of claim 19, wherein scanning the tracked traffic comprises:
searching for an incremental call sequence; and
counting a number of occurrences of a particular pattern in the tracked traffic.

21. The machine accessible medium of claim 20 wherein the incremental call sequence is one of an incremental host address call sequence or an incremental port number call sequence.

22. The machine accessible medium of claim 19, wherein uploading a plurality of malicious network traffic patterns comprises:
reading a plurality of malicious traffic pattern descriptions from one of a file or a user interface entry;
validating the syntax and semantics of the malicious traffic pattern descriptions; and
activating the malicious traffic pattern descriptions.

23. The machine accessible medium of claim 16, wherein triggering an event comprises:
triggering an event for automatic reaction against a detected network threat, the event comprising at least one of exporting information about detected malicious traffic, logging data related to the malicious traffic, sending notification to an administrator of an attacked node, blocking traffic from a host who generates the detected malicious traffic, closing an attacked port, additional algorithmic analyses.
